(19) United States
(12) Patent Application Publication
(10) Pub. No.: US 2024/0388607 A1
(43) Pub. Date: Nov. 21, 2024

(54) Use of high-level requirements and system modeling tools to automatically validate/generate security configurations for distributed communications systems

(71) Applicant: Real-Time Innovations, Inc., Sunnyvale, CA (US)

(72) Inventors: Paul Norman Pazandak, Bloomington, MN (US); Hila Ben Abraham, Chesterfield, MO (US); Jose Maria Lopez Vega, Granada (ES); Gerardo Pardo-Castellote, Santa Cruz, CA (US)

(21) Appl. No.: 18/664,023

(22) Filed: May 14, 2024

Related U.S. Application Data
(60) Provisional application No. 63/466,918, filed on May 16, 2023.

(51) Int. Cl. H04L 9/40; H04L 41/082

(52) U.S. Cl. CPC H04L 63/20; H04L 41/082

(57) ABSTRACT

Generating security configurations for data-centric communications system methods and systems are provided for visually modeling and validating cybersecurity configurations. Computer implemented and software operable methods provide a level of automation not possible in a manual fashion and provides a significant level of efficiency, accuracy and effectiveness regarding (cyber) security between data producers and consumers in data exchange systems. In a specific example, the method details methods for generating security configurations for Data Distributed Service (DDS) systems. The methods can be extended by implementing operable translation code for interpreting STRIDE threat security policies and translating them into, respectively, the security policies or DDS security policies.

### CROSS-REFERENCE TO RELATED APPLICATIONS

This application claims priority from U.S. Provisional Patent Application 63/466,918 filed May 16, 2023, which is incorporated herein by reference.

### FIELD OF THE INVENTION

This invention relates to methods for creating, validating, and generating security configurations for distributed communication systems.

### BACKGROUND OF THE INVENTION

Data Distribution Service (DDS) security is currently configured by handcrafting XML configuration files. These files need to be manually created for, and included with, every running application using DDS Security within a system. A system could have a few DDS applications to several hundred. This could result in the need to generate hundreds or thousands of files. These files specify the values for numerous DDS security configuration settings. The configuration files are read by Connext each time an application starts up. These files are only used when the customer is using the DDS Security features of Connext.

Today, all of these files need to be written by hand. The present invention advances the art towards more efficient Data Distribution Service (DDS) security methods and systems.

### SUMMARY OF THE INVENTION

A method is provided for visually modeling and validating cybersecurity configurations to generate security configurations for Data Distributed Service (DDS) systems. The method is a computer implemented/software operable method providing a level of automation not possible in a manual fashion and provides a significant level of efficiency, accuracy and effectiveness regarding (cyber) security between data producers and consumers in data exchange systems. The method in one embodiment is characterized by a computer system having a software implemented and operable data-centric model of a Data Distribution Service (DDS) data exchange system exchanging data between data producers and data consumers. The Data Distribution Service (DDS) data exchange system has security settings. The data-centric model is defined by DDS constructs and DDS security policies, where the DDS constructs include (one or more) DDS topics to which the data producers can publish on and the data consumers can subscribe to. The DDS security policies are domain security policies defining protections for RTPS packets sent within one or more DDS domains and topic security policies defining protections for RTPS packets with the DDS topics. The DDS constructs and the DDS security policies are linked to each other within the data-centric model by assigning the DDS security policies to the DDS topics and the one or more DDS domains. Further on the computer system a software implemented and operable validation code is implemented for validating the domain security policies and the topic security policies for the data centric model, where the validating is performed with a validation model. An example of the validation is provided as a rule-based model, but a skilled artisan would readily appreciate that other models could be used. Further the computer system generates a set of security configuration files from the validating step and from the validation model, where the set of security configuration files are used by the Data Distribution Service (DDS) data exchange system to configure the security settings of the Data Distribution Service (DDS) data exchange system.

The method can be extended by the computer system further having a software implemented and an operable translation code for interpreting STRIDE threat security policies and translating them into the DDS security policies.

In another embodiment, a method is provided for visually modeling and validating cybersecurity configurations to generate security configurations for data-centric communications system. This method as well is a computer implemented/software operable method providing a level of automation not possible in a manual fashion and provides a significant level of efficiency, accuracy and effectiveness regarding (cyber) security between data producers and consumers in data exchange systems. The method in this embodiment is characterized by a computer system having a software implemented and operable data-centric model of a data exchange system exchanging data between data producers and data consumers. The data exchange system has security settings. The data-centric model is defined by communications constructs and communications security policies, where the communications constructs include one or more data types to which the data producers can send on and the data consumers can receive. The communications security policies define protections for the data sent from the data producers to the data consumers. The communications constructs and the communications security policies are linked to each other within the data-centric model by assignment of the security policies to the data types, or to the data itself. Further on the computer system a software implemented and operable validation code is used for validating the defined protections for the data centric model, where the validating is performed with a validation model. Further on the computer system a set security configuration files is generated from the validating step and from the validation model, where the set of security configuration files are used by the data exchange system to configure the security settings of the data exchange system.

Likewise, the method in this embodiment can also be extended by the computer system further having a software implemented and an operable translation code for interpreting STRIDE threat security policies and translating them into the security policies.

The methods steps of the invention could further be defined by the following:
1. Creation of a data-centric model of a system, which can be created e.g. by a plugin. Create, generate, or acquire a data-centric model of the system. This can be a visual, textual, or binary representation. At a minimum, this high-level system description will describe the data producers and data consumers in the system.
   a. The model will describe each of the types of data that will be exchanged between producers and consumers.
   b. The model will describe the data and the data structures produced by each data producer and the data consumed by each data consumer.
   c. The model will include security configuration metadata that directly or indirectly describes how the data shall be protected when sent between producers to consumers.
   d. The model may describe performance and other metadata about the system, the data, or the data producers and consumers.
   e. The model may describe a conceptual implementation of the system that omits details of the specific environment in which the system will be deployed.
   f. The model may include details of a specific instantiation of the system that supplies execution environment details.
2. Data validation. The data-centric system modeling tool/solution may include algorithms that validate the model data to ensure that the model data is compliant with the model's rules.
3. Automated generation of security policies. For each Policy Decision Point (PDP also referred to as PEP (Policy Enforcement Point, see FIG. 1)) in the security architecture, create data producer and data consumer security policies that can then be enforced.
   a. By direct inspection of the model(s) from (1), execute implemented algorithms that will produce a set of security policy descriptions that include the list of data types that each data producer can or be allowed to produce and each data consumer can or may be able to consume.
   b. These policies will be used (by Policy Decision Point software/algorithms) as the rules that will restrict the data producers so they can only produce or be allowed to produce the set of listed data types; and restrict the data consumers so they can only consume or may be able to consume the set of listed data types.
   c. The algorithms will format these security policies according to the requirements for each PDP that will be running within the system.
   d. Each specific type of PDP may require using a different format, and may require different information metadata from the models.
      i. For example, a MACSec PDP may require IP addresses; an OS kernel PDP such as eBPF may require port numbers; a DDS PDP will require formatted data that is compliant with the OMG DDS Security standard; a network PDP such as an intelligent switch additional LAN information.
   e. The metadata required/used by each PDP may add additional controls on the behavior of the data producers and consumers specific to each type of PDP.
      i. For example, a DDS PDP policy may include information about how the data shall be encrypted.

Automated Generation of Security Policies:
The algorithms that read the model descriptions and generates the security policies will be realized as executable software. This software may exist as standalone software, or it may be embedded within another piece of software. The algorithms could also be a more general-purpose tool such as a large language model (e.g., ChatGPT, BARD, etc).

There are many gaps that exist today that the current invention addresses.
The current manually constructed file creation process is error prone;
It is impossible to automatically validate the correctness of the files (other than formatting correctness);
No tools exist to provide traceability from the security configuration settings back to system requirements;
Current existing software or system modeling tools (such as Cameo, Enterprise Architect, etc.) do not support modeling, visualizing, or validating the DDS security policies/settings;
Current existing tools (such as Ansible/Terraform) do not allow one to model/specify deployment-specific DDS security policies;
   A DDS application can be deployed into many different systems/locations, and for different users/purposes. This may not be known when the system is modeled. No tools exist today that enable the user to specify additional/different DDS security configurations on a per-deployment basis.
There are no tools that can utilize software/system models or specifications to auto-generate the DDS security configuration files;
There is no ability to utilize software/system models to generate data-centric security policies for the operating system, network, and other policy enforcement points within a system.

Note that today, other communications protocols use ON or OFF granularity of security. DDS supports many additional configuration knobs that both makes DDS Security more powerful, and more complex to configure.

This same problem may exist for any current or future distributed communications protocol that supports extensive configuration of security properties.

### BRIEF DESCRIPTION OF THE DRAWINGS

FIG. 1 shows according to an exemplary embodiment of the invention that the descriptions of the security policies for each DDS application can be used by system modeling tools (the top box in diagram) to automatically generate security policies that can then be used to configure security at multiple layers within a running system (as shown by the arrows on the right-hand-side of the diagram).

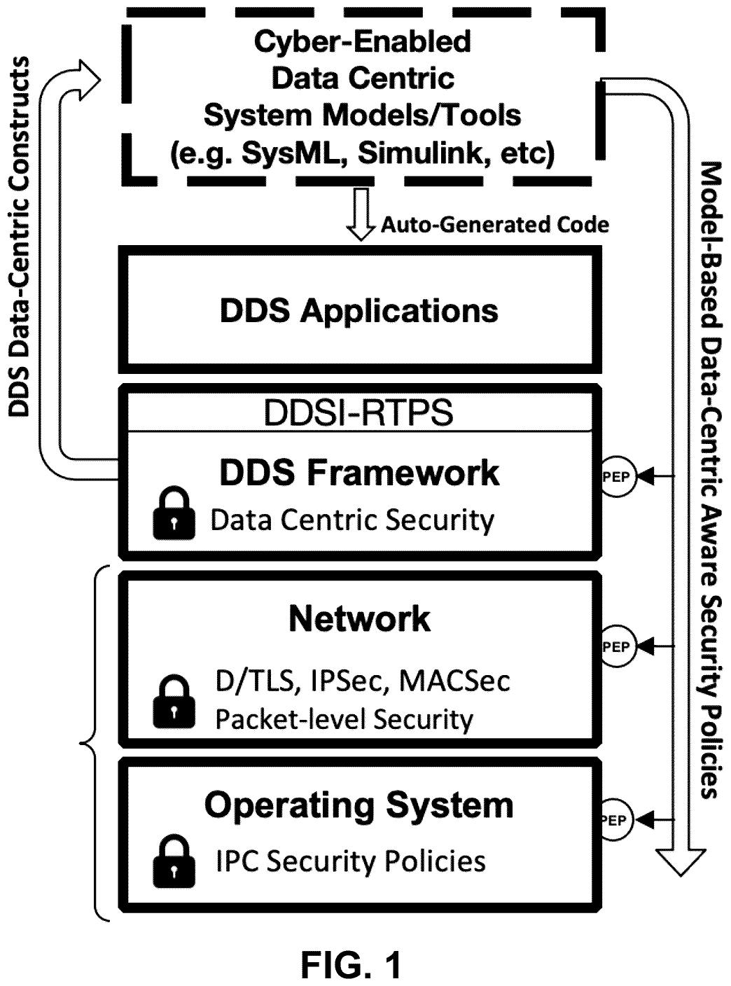

FIG. 2 shows according to an exemplary embodiment of the invention a new process for modelling DDS security within an MBSE tool.

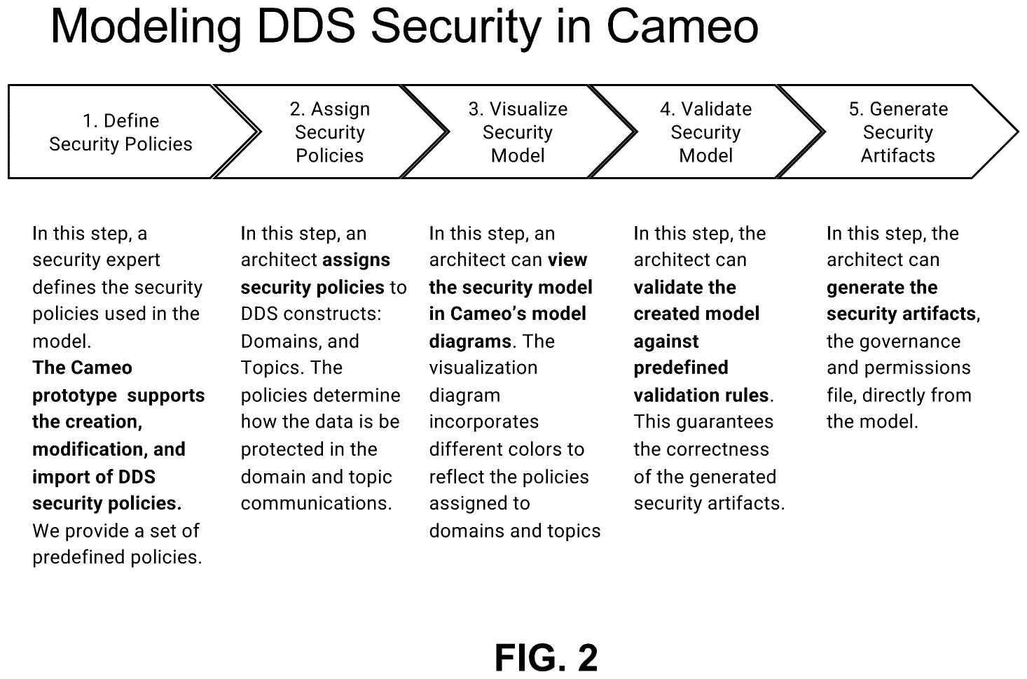

FIG. 3 shows according to an exemplary embodiment of the invention domains and topics in an example model.

FIG. 4 shows according to an exemplary embodiment of the invention a Cameo Model example without security legend.

FIG. 5 shows according to an exemplary embodiment of the invention a Cameo model example with automatically generated security legend.

FIG. 6 shows according to an exemplary embodiment of the invention DDS trust boundaries.

FIG. 7 shows according to an exemplary embodiment of the invention STRIDE Properties and DDS mitigation techniques.

FIG. 8 shows according to an exemplary embodiment of the invention STRIDE indicators in policies and assignment tables.

FIG. 9 shows according to an exemplary embodiment of the invention packet and payload protection in DDS security.

FIG. 10 shows according to an exemplary embodiment of the invention an example of a governance file (XML).

FIG. 11 shows according to an exemplary embodiment of the invention an example of a permissions file (XML).

### DETAILED DESCRIPTION

At its core, embodiments of the invention incorporate the specification of data-centric communications security policies into the description (models) of software systems. The models may represent any phase of the software system, e.g., from conceptual phase to deployment phase. This detailed documentation of the security policies enables us to solve all of the problems outlined above.

The system models may be described in text format, graphical format, or more advanced modeling tools (e.g., SysML, Dassault Cameo, Enterprise Architect, IBM Rhapsody, Ansible, Terraform, etc).

Additional embodiments of the invention include:
the ability to graphically visualize the DDS Security policies as an integral part of the visualization of a software system description.
the ability to analyze and validate the description of the DDS security policies within the model.
the ability to generate the required DDS security configuration files from these descriptions.
the creation of higher-level security constructs (a naming system) that encapsulate several DDS Security settings so they can be referenced as a single security policy.
the application of the STRIDE security policy framework to data-centric communications security.
the ability to generate non-DDS (but DDS-aligned) security policies that can be used to enforce application security requirements within other parts of a system (e.g., operating system, network, etc.)

Customer Benefits: Incorporating security early in the system design process and making it a first-class citizen in modeling time allows cyber experts to 1) consider the security implications of the system design, 2) incorporate appropriate security measures throughout the design process, and 3) understand the risks and take proactive steps to mitigate them. No modeling tools today support security modeling of distributed data-centric systems.

### Details and Reference Implementation

### DDS Security Policies as First Class MBSE Constructs

A DDS Security Policy is a new concept created for this effort. A DDS policy determines which security algorithms and mechanisms will be applied by the middleware to the different messages and sub messages sent by DDS publishers. Specifically, two types of DDS Security Policies are defined:
a. Domain Security Policy: The collection of DDS attributes that define the protections to be set to all the RTPS packets sent within a DDS Domain. Those attributes map to the domain-rule attributes defined in the OMG governance file.
b. Topic Security Policy: The collection of DDS attributes that define the protections that should be configured to the payload and metadata parts of the RTPS packets associated with a specific topic.

By making DDS security policies MBSE constructs, a new way to link DDS security policies to DDS constructs within a modeling tool is introduced, and this increases the cybersecurity traceability back to SysML.

### Reference Implementation

Two new tables have been created in the Cameo plugin: Domain Security policies and Topic Security Policies. Both tables were placed in the DDS Security Policies package. The embodiments support two options to add policies to the model (See figures labeled ‘Two New Tables for Domain and Topic Policies’ and ‘Import Security Policies Menu’ in priority document to which this application claims the benefit):
1. Craft security policies within the Cameo prototype.
2. Import security policies from a library of predefined policies.

An example of an import file is shown in a figure labeled ‘Policies.xml Example File (for import)’ in priority document to which this application claims the benefit. The example import file includes two domain policies and three topic policies.

A new XML Schema Definition file (XSD) was created to define the elements, attributes, and data types of the DDS Security policies. An example of an XML Schema Definition file (XSD) is shown in figure referring to ‘RTI PoC Policies XML Schema File’ in priority document to which this application claims the benefit.

Once imported, the policy tables in Cameo are populated with the values taken from the imported attributes and their values. The XML Schema Definition file (XSD) file also shows three “STRIDE Calculation” columns, which will be addressed infra.

One of the core purposes of the implementation reference is the creation of security models through the assignment of Domain and Topic Security Policies to DDS Domains and Topics, respectively.

For that purpose, two assignment tables were created: one for assigning domain policies to domains, and another for assigning topic policies to topics. Four total assignments in the two assignment tables were used (See figure labeled ‘Domain & Topic Policy Assignment’ in priority document to which this application claims the benefit). Two for domains and two for topics.

DDS Security legend for the DDS Internal Block Diagram (IBD)

The new legend defines the styles of the DDS model elements, domains and topics, and visually groups or differentiates them according to their assigned security policy:
The style of the blocks, representing the domain participants, is determined by the domain security policy assigned to the domain.
The style of the lines connecting the blocks, representing the topics, is determined by the topic policy assigned to the topics.

The legend simplifies and increases the readability of the security configuration by highlighting the policy assignments. In addition, the styles applied to DDS model elements can be updated when the model or security assignments change.

In an exemplary embodiment, an exemplary prototype (also referred to as a DDS Security Cameo Plugin) offers the capabilities to visualize the security model through the automated generation of Legends, which can be added to the DDS IBD Diagram.

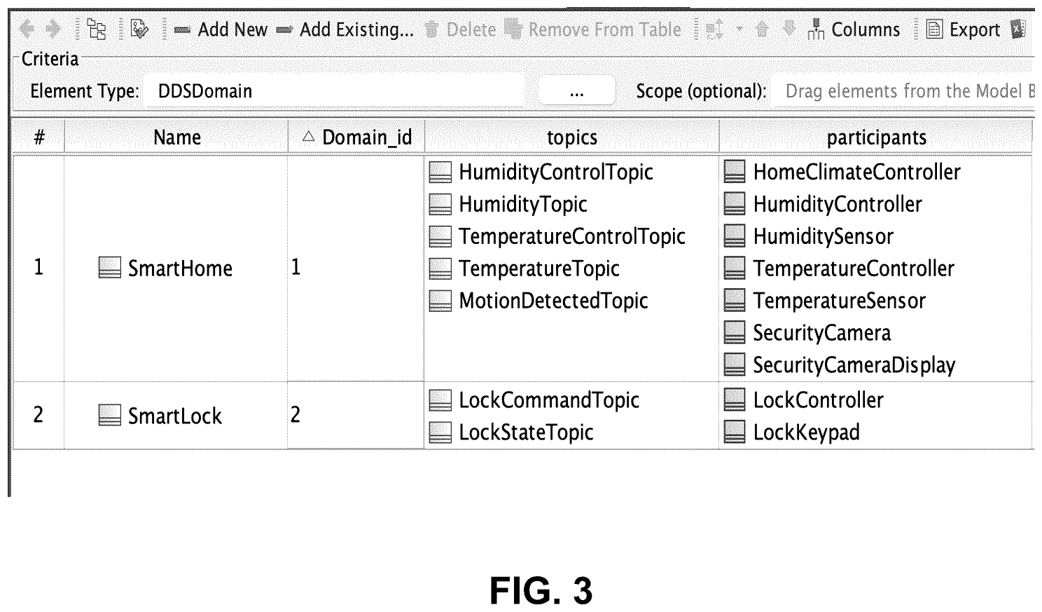

To demonstrate a legend, consider the architecture of our model example, as listed in the FIG. 3. As shown, the model has two domains, SmartHome and SmartLock, each contains a list of DDS topics. To demonstrate the visualization capabilities, the assignment described before was used, and can be summarized as follows:
Domain Assignment 1: “Mitigate Outsider Spoofing” to the SmartHome Domain.
Domain Assignment 2: “Mitigate Information Disclosure” to the SmartLock Domain.
Topic Assignment 1: “Mitigate Data Tampering” to the TemperatureControl Topic.
Topic Assignment 2: “Encrypt Topic submessages” to the LockCommand Topic.

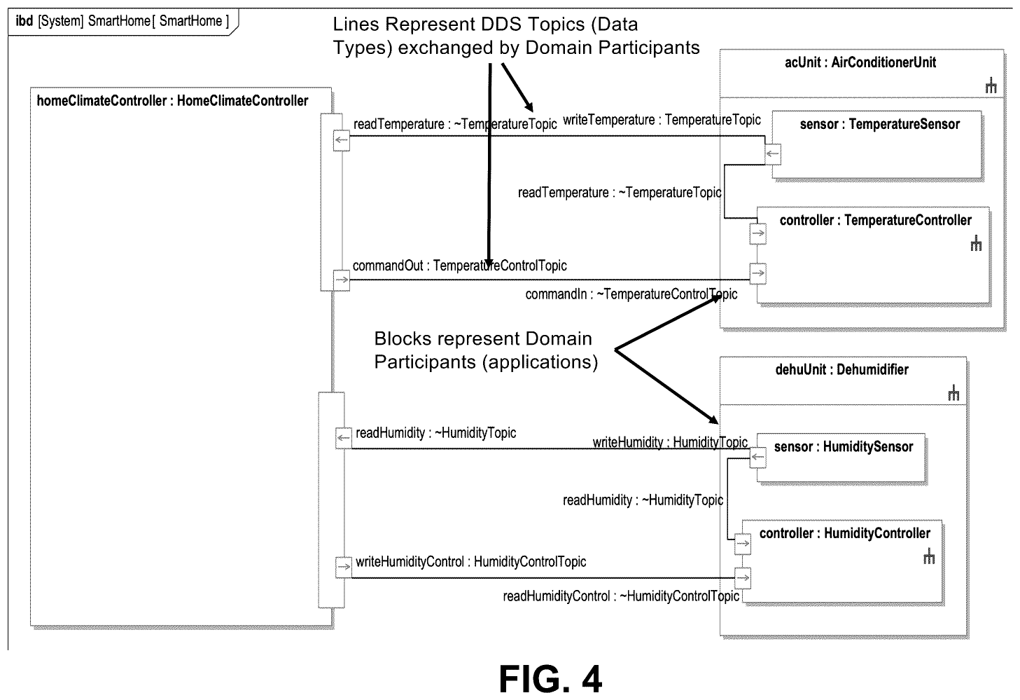

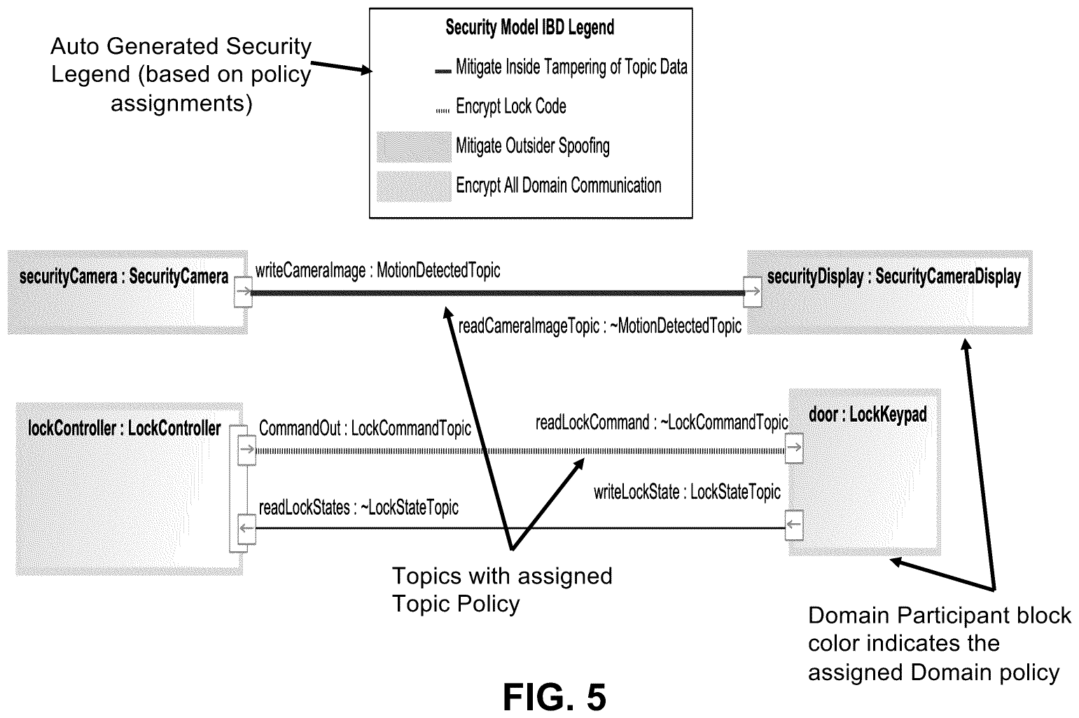

FIGS. 4-5 show the example model Diagram with and without the generated security legend of the assigned policies.

### DDS Security Validation Suite

A new DDS Security validation ruleset was defined. The DDS Security validation suite in one embodiment has 27 rules in three different categories: sanity checks, unnecessary performance hits, and security recommendations. Each rule is defined in the form of an IF condition, or a combination of IF conditions, and specifies the message to be presented in case of a false return. In addition, each rule specifies the severity and whether the auto-generation of the security artifacts should be blocked in case of a false return. The table below lists the rules defined in one embodiment defined as a DDS Security Validation Ruleset.

| | | | | Block |
|---|---|---|---|---|
| | | | | artifacts |
| # | Rule | Message | Severity | generation? |
| 1 | DomainPolicy.allow_unauthenticated_ | “allow unauthenticated | Error | Yes |
| | participants == undefined | participants” is undefined | | |
| 2 | DomainPolicy.enable_join_access_ | “enable join access control” is | Error | Yes |
| | control == undefined | undefined | | |
| 3 | DomainPolicy.discovery_protection_ | “discovery protection kind” is | Error | Yes |
| | kind == undefined | undefined | | |
| 4 | DomainPolicy.liveliness_protection_ | “liveliness protection kind” is | Error | Yes |
| | kind == undefined | undefined | | |
| 5 | DomainPolicy.rtps_protection_ | “rtps protection kind” is | Error | Yes |
| | kind == undefined | undefined | | |
| 6 | TopicPolicy.enable_discovery_ | “enable discovery protection” | Error | Yes |
| | protection == undefined | is undefined | | |
| 7 | TopicPolicy.enable_liveliness_ | “enable liveliness protection” | Error | Yes |
| | protection == undefined | is undefined | | |
| 8 | TopicPolicy.metadata_protection_ | “metadata protection kind” is | Error | Yes |
| | kind == undefined | undefined | | |
| 9 | TopicPolicy.data_protection_ | “data protection kind” is | Error | Yes |
| | kind == undefined | undefined | | |
| 10 | TopicPolicy.enable_read_access_ | “enable read access control” | Error | Yes |
| | control == undefined | is undefined | | |
| 11 | TopicPolicy.enable_write_access_ | “enable write access control” | Error | Yes |
| | control == undefined | is undefined | | |
| 12 | DomainPolicy.allow_unauthenticated_ | Invalid RTPS protection: | Error | Yes |
| | participants == TRUE | “rtps protection kind” must | | |
| | AND | set to none if allowing | | |
| | DomainPolicy.rtps_protection_ | unauthenticated participants | | |
| | kind != NONE | | | |
| 13 | DomainPolicy.discovery_ | No discovery protection set | Warning | No |
| | protection_kind NONE AND | for the domain. Topic | | |
| | TopicPolicy.enable_discovery_ | discovery protection is | | |
| | protection == TRUE | ignored | | |
| 14 | DomainPolicy.liveliness_ | No liveliness protection set | | |
| | protection_kind = NONE AND | for the domain. Topic | | |
| | TopicPolicy.enable_liveliness_ | liveliness protection is | | |
| | protection == TRUE | ignored | | |
| 15 | DomainPolicy.rtps_protection_ | Redundant topic discovery | Info | No |
| | kind == ENCRYPT AND | protection configured. | | |
| | DomainPolicy.discovery_ | | | |
| | protection_kind == ENCRYPT | | | |
| | DomainPolicy.rtps_protection_ | Redundant topic discovery | Info | No |
| | kind SIGN AND | protection configured. | | |
| | DomainPolicy.discovery_ | | | |
| | protection_kind == SIGN | | | |
| 16 | DomainPolicy.rtps_protection_ | Redundant topic discovery | Info | No |
| | kind | protection configured. | | |
| | ENCRYPT_WITH_ORIGIN_ | | | |
| | AUTHENTICATION AND | | | |
| | DomainPolicy.discovery_protection_ | | | |
| | kind | | | |
| | ENCRYPT_WITH_ORIGIN_ | | | |
| | AUTHENTICATION | | | |
| 17 | DomainPolicy.rtps_protection_ | Redundant topic discovery | Info | No |
| | kind | protection configured. | | |
| | SIGN_WITH_ORIGIN_ | | | |
| | AUTHENTICATION AND | | | |
| | DomainPolicy.discovery protection_ | | | |
| | kind | | | |
| | SIGN_WITH_ORIGIN_ | | | |
| | AUTHENTICATION | | | |
| 18 | DomainPolicy.rtps_protection_ | Redundant liveliness | Info | No |
| | kind ENCRYPT AND | protection configured. | | |
| | DomainPolicy.liveliness_ | | | |
| | protection_kind == ENCRYPT | | | |
| 19 | DomainPolicy.rtps_protection_ | Redundant liveliness | Info | No |
| | kind SIGN AND | protection configured. | | |
| | DomainPolicy.liveliness_ | | | |
| | protection_kind == SIGN | | | |
| 20 | DomainPolicy.rtps_protection_ | Redundant liveliness | Info | No |
| | kind | protection configured. | | |
| | ENCRYPT_WITH_ORIGIN_ | | | |
| | AUTHENTICATION AND | | | |
| | DomainPolicy.liveliness | | | |
| | protection kind | | | |
| | ENCRYPT_WITH_ORIGIN_ | | | |
| | AUTHENTICATION | | | |
| 21 | DomainPolicy.rtps_protection_ | Redundant liveliness | Info | No |
| | kind | protection configured. | | |
| | SIGN_WITH_ORIGIN_ | | | |
| | AUTHENTICATION AND | | | |
| | DomainPolicy.liveliness_ | | | |
| | protection_kind | | | |
| | SIGN_WITH_ORIGIN_ | | | |
| | AUTHENTICATION | | | |
| 22 | (DomainPolicy.rtps_protection_ | Redundant metadata origin | Info | No |
| | kind = | authentication: rtps-level | | |
| | SIGN_WITH_ORIGIN_ | origin authentication already | | |
| | AUTHENTICATION) OR | enabled. | | |
| | (DomainPolicy.rtps_protection_ | | | |
| | kind | | | |
| | ENCRYPT WITH_ORIGIN_ | | | |
| | AUTHENTICATION) AND | | | |
| | (TopicPolicy.metadata_protection_ | | | |
| | kind = | | | |
| | SIGN_WITH_ORIGIN_ | | | |
| | AUTHENTICATION) OR | | | |
| | (TopicPolicy.metadata_protection_ | | | |
| | kind = | | | |
| | ENCRYPT_WITH_ORIGIN_ | | | |
| | AUTHENTICATION) | | | |
| 23 | (DomainPolicy.rtps_protection_ | All of the Topics in the | Info | No |
| | kind SIGN) OR | domain are enabling metadata | | |
| | (DomainPolicy.rtps_protection_ | origin authentication: | | |
| | kind = ENCRYPT) AND ALL | consider using rtps-level | | |
| | ((TopicPolicy.metadata_protection | origin authentication instead. | | |
| | kind | | | |
| | SIGN_WITH_ORIGIN_ | | | |
| | AUTHENTICATION) OR | | | |
| | (TopicPolicy.metadata_protection | | | |
| | kind = | | | |
| | ENCRYPT_WITH_ORIGIN_ | | | |
| | AUTHENTICATION)) | | | |
| 24 | (TopicPolicy.metadata_protection_ | Metadata and | | |
| | kind = SIGN) OR | configured: this is only | | |
| | (TopicPolicy.metadata_protection_ | needed if you areusing | | |
| | kind = | Persistence Service in your | | |
| | SIGN_WITH_ORIGIN_ | system. | | |
| | AUTHENTICATION) AND | | | |
| | TopicPolicy.data_protection_ | | | |
| | kind = SIGN | | | |
| 25 | (TopicPolicy.metadata_protection_ | Metadata and data encryption | Info | No |
| | kind ENCRYPT) OR | configured: this is only | | |
| | (TopicPolicy.metadata_protection_ | needed if you are using | | |
| | kind = | Persistence Service in your | | |
| | ENCRYPT_WITH_ORIGIN_ | system. | | |
| | AUTHENTICATION) AND | | | |
| | TopicPolicy.data_protection_ | | | |
| | kind = ENCRYPT | | | |
| 26 | Domain has a domain policy AND | No topic policy assigned in | Error | |
| | None of the topics in the domain | the domain. This would result | | |
| | has a topic policy | in no protection against | | |
| | | domain/topic-insiders. If this | | |
| | | is the intended behavior, then | | |
| | | please be explicit and set a | | |
| | | “no topic protection” policy to | | |
| | | the topics in the domain. You | | |
| | | can do this by assigning the | | |
| | | policy to the “*” topic. | | |
| 27 | if the ‘Information Disclosure’ | Topic is encrypted but a | | |
| | policy is assigned to a topic but | domain insider may be | | |
| | isn't assigned to its domain | exposed to liveliness and | | |
| | | discovery information. If this | | |
| | | presents a risk, consider | | |
| | | moving the topic to an | | |
| | | encrypted domain | | |

### Reference Implementation

The reference implementation (Cameo Plugin) implements all the 27 rules. This means that the Security Policies and Security Policy Assignments are checked based on a predefined-but extensible-validation ruleset in an automated way.

To validate the policies and their assignments, choose AnalyzeValidationValidate from the top menu, and select the DDS Security Validation Suite. When an error/warning occurs, a “validation results” window is opened at the bottom of the screen with the list of failed tests.

Auto Generation of Security Artifacts from a DDS Security Model

Currently, DDS Security configuration files are written manually. This is an error-prone process that can lead to misconfigurations that can put the system at risk. Moreover, security misconfiguration could result in unexpected system behavior that would lead to longer debugging and deployment times.

Generating the security artifacts from the model not only guarantees the structural correctness of the configuration files, but it can also validate the security dependencies as a prerequisite step. Hence, the automatic generation of validated security artifacts from the model takes a holistic approach and considers the security posture of the entire system, so the generated artifacts are semantically correct.

### Reference Implementation

The exemplary prototype as referred to earlier supports exporting the DDS security artifacts, the Governance and Permissions files, as described in the OMG standard. Note that failed validation tests may prevent the export functionality. The generated Governance of an example model and policy assignments is presented in a figure labeled ‘Automatically Generated Governance File from the Model Example’ in priority document to which this application claims the benefit.

Unlike the Governance File, the exported Permissions File can be generated from the model, even if no security assignment was made to domains or topics. The prototype simply goes over all the domain participants in the model and generates an “allow rule” for each topic it subscribes to or publishes on. The prototype then sets a default “deny rule” for all other topics. The prototype creates one permissions file for each domain participant. The figure, labeled ‘Automatically Generated DDS Permissions File from the Model Example’ in priority document to which this application claims the benefit, shows the content of one of the generated permissions files in an example model (for the TemperatureController).

### STRIDE to DDS Security Mapping

Threat modeling, and specifically the STRIDE methodology, is an approach for defining the system's trust boundaries and assessing the security risks of a distributed system.

In this invention a mapping between DDS Security and the STRIDE threat methodology was created so architects modeling their systems could automatically understand and evaluate the STRIDE mitigations that will be enforced by the DDS security policies included in the model. In other words, this work establishes a mapping between a common threat modeling language with the DDS Security language.

### Data-Centric STRIDE Modeling

STRIDE was designed to model host-centric systems where clear end-to-end data flows can be modeled. The first step in applying STRIDE is identifying all the flows in the systems using data flow diagrams (DFDs). The data-centric paradigm defines the data as the primary asset to protect, not the channel between hosts. Moreover, one of the core advantages of data-centric system is the support for a dynamic number of participants in the systems. Hence, not all the end-to-end flows are known during modeling time, and applications or data writer/readers can come and go throughout the lifetime of the system. Therefore, applying traditional STRIDE to specific data flows in a data-centric system is not a sustainable or scalable approach. To the best of the inventors' knowledge, there is no common approach to data-centric threat modeling or known best practices to applying STRIDE to data-centric systems.

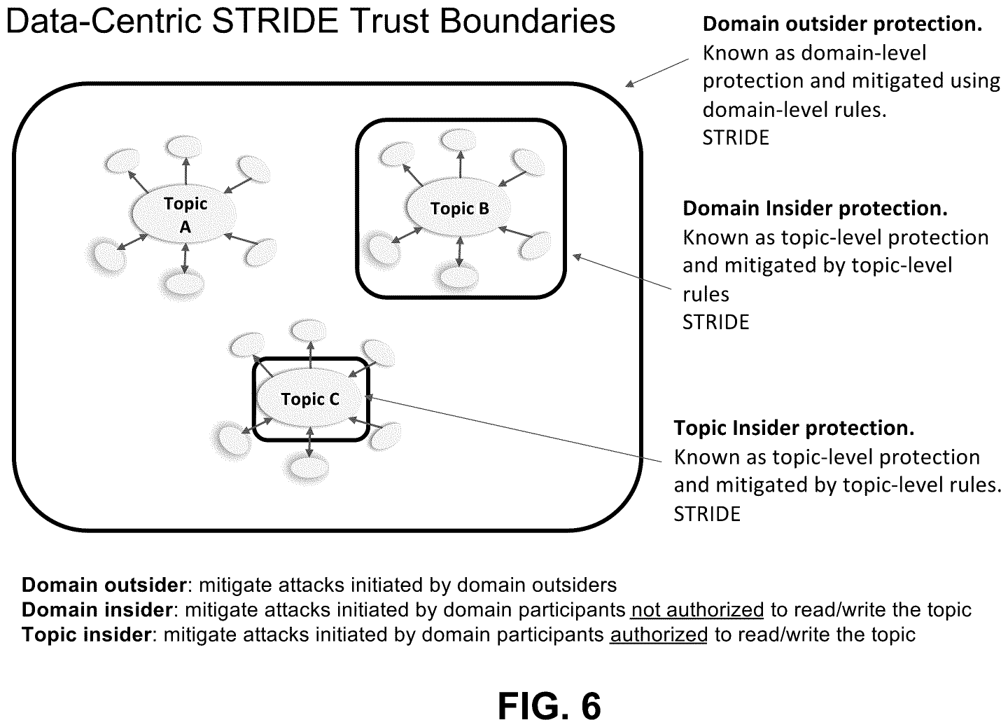

To address this challenge, a new approach was developed for the purpose of this invention for applying STRIDE to data-centric models. Instead of identifying all the dynamic communication flows in a system, three boundaries for each topic in a DDS system was defined. Each boundary defines who is allowed to read/write the topic, and the mitigation techniques in place to prevent unauthorized access. To align with threat modeling language, unauthorized access as one of the STRIDE threats for each of the three DDS boundaries was defined. FIG. 6 shows the three trust boundaries, defines the authorized access group, and presents the STRIDE mitigations supported in each boundary.

By applying STRIDE to data instead of channels, one would need three new types of STRIDE threat boundaries:
1. Inner boundary group (Topic Insider): Applications authorized to read or write the topic.
2. Mid-boundary group (Domain Insider): Applications not authorized to read/write the topic but can read/write a different topic in the domain.
3. Outer boundary group: Applications not authorized to read or write to any topic within the domain.

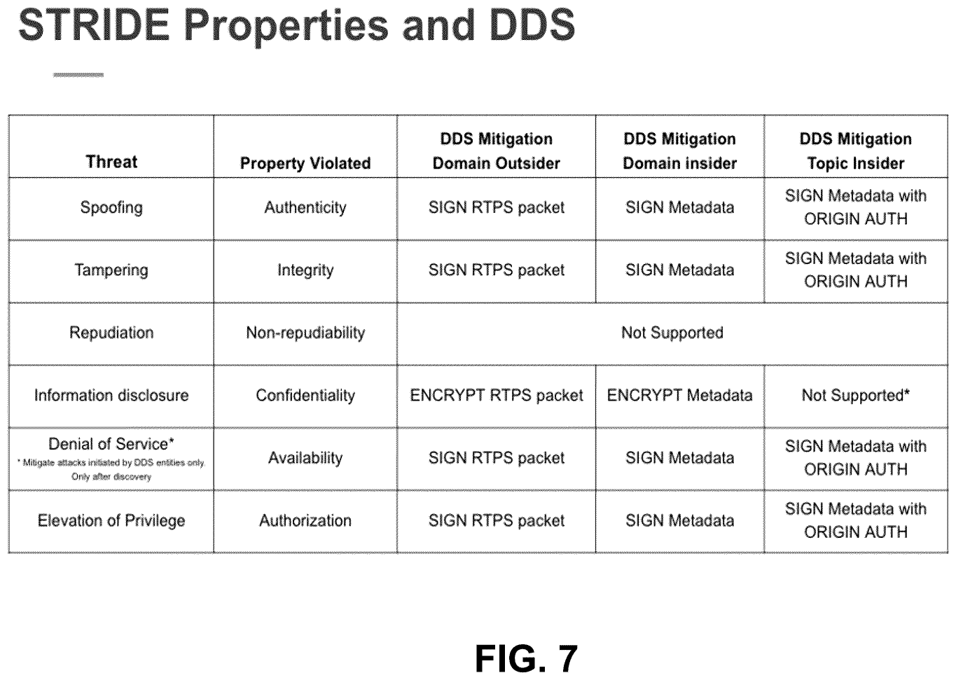

A summary of their properties for each one of different boundaries is shown in FIG. 7.

STRIDE DDS Security: Threat Definitions and DDS Policies

In this section, the STRIDE threats for each boundary are defined, and along with their corresponding mitigations in the form of a Domain or Topic policy.

### Domain-Outsider:

Domain Outsider*-STRIDE Threats to DDS Definitions

| | THREAT | DESCRIPTION |
|---|---|---|
| S | Spoofing | Prevent an outsider* from impersonating a |
| | | legitimate Domain Participant. |
| T | Tampering | Prevent an outsider* from sending data or |
| | | metadata into the domain. |
| R | Repudiation | Not Supported |
| I | Information Disclosure | Prevent an outsider* from reading data or |
| | | metadata published in the domain. |
| D | Denial of Service | Prevent an outsider* from using DDS internals |
| | | to create a denial-of-service attack. (Such as |
| | | injecting RTPS messages that can prevent a |
| | | legitimate participant from receiving or |
| | | sending data). |
| E | Elevation of Privilege | Prevent an outsider* from operating with non- |
| | | legitimate Domain Participant privileges for |
| | | that domain (determined by the Permissions |
| | | CA). |
| | DDS Domain Policy | |
| STRIDE Threats | Attribute | Value |
| Spoofing/ | allow_unauthenticated_participants | FALSE |
| Tampering/ | enable_join_access_control | TRUE |
| Denial of Service/ | discovery_protection_kind | NONE |
| Elevation of | liveliness_protection_kind | NONE |
| privilege | rtps_protection_kind | SIGN (at a |
| | | minimum) |
| Repudiation | Not Supported (application-level mitigation) | |
| Information | allow_unauthenticated_participants | FALSE |
| Disclosure | enable_join_access_control | TRUE |
| | discovery_protection_kind | NONE |
| | liveliness_protection_kind | NONE |
| | rtps_protection_kind | ENCRYPT |
| | | (at a |
| | | minimum) |

*Outsider: both DDS and non-DDS participant not authorized in the DDS domain

### Domain-Insider Threats:

Domain Insider*-STRIDE Threats to DDS Definitions

| | THREAT | DESCRIPTION |
|---|---|---|
| S | Spoofing | Prevent a domain insider* from impersonating a |
| | | legit topic DataWriter/DataReader. |
| T | Tampering | Prevent a domain insider* from writing topic |
| | | data to a protected topic. |
| R | Repudiation | Not Supported |
| I | Information Disclosure | Prevent a domain insider* from reading topic |
| | | data from a protected topic. Note that topic |
| | | metadata carried by liveliness & discovery will |
| | | still be visible to all domain participants |
| | | authorized into the domain. |
| D | Denial of Service | Prevent a domain insider* from injecting RTPS |
| | | messages that can prevent a legit topic |
| | | DataWriter/DataReader from sending/receiving |
| | | data. |
| E | Elevation of Privilege | Prevent a domain insider* from operating with |
| | | non-legitimate DomainParticipant privileges for |
| | | a protected topic (determined by the |
| | | Permissions CA). |

Domain Insider-STRIDE Threats to DDS Mapping

| STRIDE | Topic Policy (Topic rule in governance file) | |
|---|---|---|
| Threats | Attribute | Value |
| Spoofing/ | enable_discovery_protection | TRUE |
| Tampering/ | enable_liveliness_protection | TRUE |
| Denial of | metadata_protection_kind | SIGN (at a |
| Service/ | | minimum) |
| Elevation of | data_protection_kind | NONE |
| Privilege | enable_read_access_control | TRUE |
| | enable_write_access_control | TRUE |
| Repudiation | Not Supported | |
| Information | enable_discovery_protection | TRUE |
| Disclosure | enable_liveliness_protection | TRUE |
| | metadata_protection_kind | ENCRYPT (at |
| | | a minimum) |
| | data_protection_kind | NONE |
| | enable_read_access_control | TRUE |
| | enable_write_access_control | FALSE |

*Domain Insider: a DDS domain participant authorized to read or write to other topic(s) in the domain but not authorized to read & write to the protected topic.

### Topic-Insider Threats:

Topic-Insider - STRIDE Threats to DDS Definitions

| | THREAT | DESCRIPTION |
|---|---|---|
| S | Spoofing | Prevent a legitimate compromised topic |
| | | DataWriter/DataReader from impersonating another |
| | | writer/reader to the topic. |
| T | Tampering | Prevent a legitimate compromised topic |
| | | DataWriter/DataReader from modifying and rewriting |
| | | topic data or metadata for a different |
| | | DataWriter/DataReader. |
| R | Repudiation | Not Supported |
| I | Information Disclosure | Not Supported |
| D | Denial of Service | Prevent a legitimate compromised topic |
| | | DataWriter/DataReader from using DDS to amplify |
| | | DOS attacks. (For example, injecting RTPS messages |
| | | that can prevent other legitimate topic |
| | | DataWriter/DataReader from sending/receiving data). |
| E | Elevation of Privilege | Prevent a legitimate compromised topic DataReader |
| | | from writing topic data. |

Topic-Insider - STRIDE Threats to DDS Mapping

| STRIDE | Topic Policy (Topic rule in governance file) | |
|---|---|---|
| Threats | Attribute | Value |
| Spoofing/ | enable_discovery_protection | TRUE |
| Tampering/ | enable_liveliness protection | TRUE |
| Denial of | metadata_protection_kind | SIGN WITH ORIGIN AUTHENTICATION |
| Service/ | data_protection_kind | NONE |
| Elevation of | enable_read_access_control | TRUE |
| Privilege | enable_write_access control | TRUE |
| Repudiation | Not Supported | |
| Information | Not Supported | |
| disclosure | | |

### Summary of STRIDE to DDS Mapping

Supported STRIDE Mitigations at Each DDS Boundary

| | | DDS | DDS | DDS |
|---|---|---|---|---|
| | | MITIGATION | MITIGATION | MITIGATION |
| | PROPERTY | DOMAIN- | DOMAIN- | TOPIC- |
| THREAT | VIOLATED | OUTSIDER | INSIDER | INSIDER |
| SPOOFING | Authenticity | SIGN RTPS | SIGN Metadata | SIGN |
| | | packet | | Metadata |
| | | | | with ORIGIN |
| | | | | AUTH |
| TAMPERING | Integrity | SIGN RTPS | SIGN Metadata | SIGN |
| | | packet | | Metadata |
| | | | | with ORIGIN |
| | | | | AUTH |
| REPUDIATION | Non-reputability | Not Supported | | |
| INFORMATION | Confidentiality | ENCRYPT RTPS | ENCRYPT | Not |
| DISCLOSURE | | packet | Metadata | Supported |
| DENIAL OF | Availability | SIGN RTPS | SIGN Metadata | SIGN |
| SERVICE | | packet | | Metadata |
| | | | | with ORIGIN |
| | | | | AUTH |
| ELEVATION OF | Authorization | SIGN RTPS | SIGN Metadata | SIGN |
| PRIVILEGE | | packet | | Metadata |
| | | | | with ORIGIN |
| | | | | AUTH |

### Reference Implementation

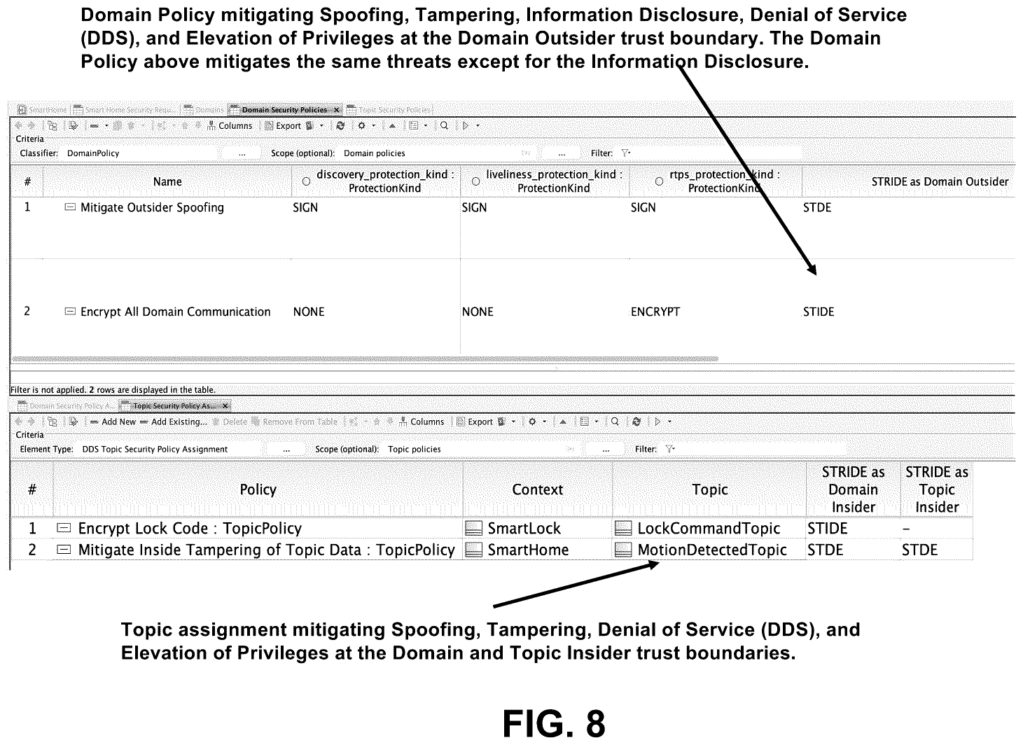

The reference implementation automatically calculates the STRIDE mitigations for each of the modeled DDS security policies, and presents it in the policies and assignment tables. The Domain Outsider boundary is mapped to a domain policy, and therefore, it is included in the Domain Policy and the Domain Assignments Tables. The Domain Insider and Topic Insider boundaries are mapped to topic policies and thus included in the Topic Policy and Topic Assignments Tables. For example, FIG. 8 shows the STRIDE columns in the Domain Security Policies Table, and in the Topics Security Assignment Table.

### Additional Information

DDS Security is an OMG open standard designed to mitigate threats in DDS networks.

### System Modeling and Cameo

Modeling is an engineering practice to formulate and illustrate the design of complex systems. Modeling tools help the system architect to gather system requirements, define, validate, and illustrate the system's design.

Cameo, previously known as NoMagic's MagicDraw, is a commercial Model-Based Systems Engineering (MBSE) environment by Dassault. Cameo's environment enables systems engineers to model their systems' components and internals using UML and SysML.

The commercial DDS for MagicDraw plugin allows users to model the DDS aspects of their system, alongside the software-related aspects, using a unified representation. Embodiments of this invention further enhances Cameo to include DDS Security information so that it can incorporate security policies into the system model, visualize the model, and auto-generate DDS Security configuration files. The DDS for MagicDraw plugin was developed circa 2017.

### DDS Security

DDS is a loosely coupled and fully decentralized data-centric pub-sub communications framework. DDS allows applications to create communication groups using the concept of domains, and to define the structure and semantics of the data using the concept of topics. Domains are used to separate network traffic into logical partitions in order to limit accessibility of specific data to a subset of applications. Applications simply define the topics, and the Domain participants (members) who will publish and subscribe to those topics. DDS takes care of all of the underlying communications between applications.

The data-centric nature of DDS enables application developers to define security protections based on the nature of shared data and the group it is being shared with. This enables DDS Security not only to provide confidentiality, authenticity, and integrity to protect the system from an outside threat, but also support fine-grained protections within the system. This is a novel yet critical evolution in distributed system security.

For instance, using DDS fine-grained security, an architect can define that all messages exchanged in a certain domain will be authenticated, but only some topics will be encrypted. Enabling fine-grained protection instead of the “encrypt all” approach provides additional and vital visibility for debugging and monitoring. This level of control also allows performance requirements to be considered.

While we will not go into the details of the DDS Security standard within this invention, we do briefly want to discuss the technical aspects relevant to this task.

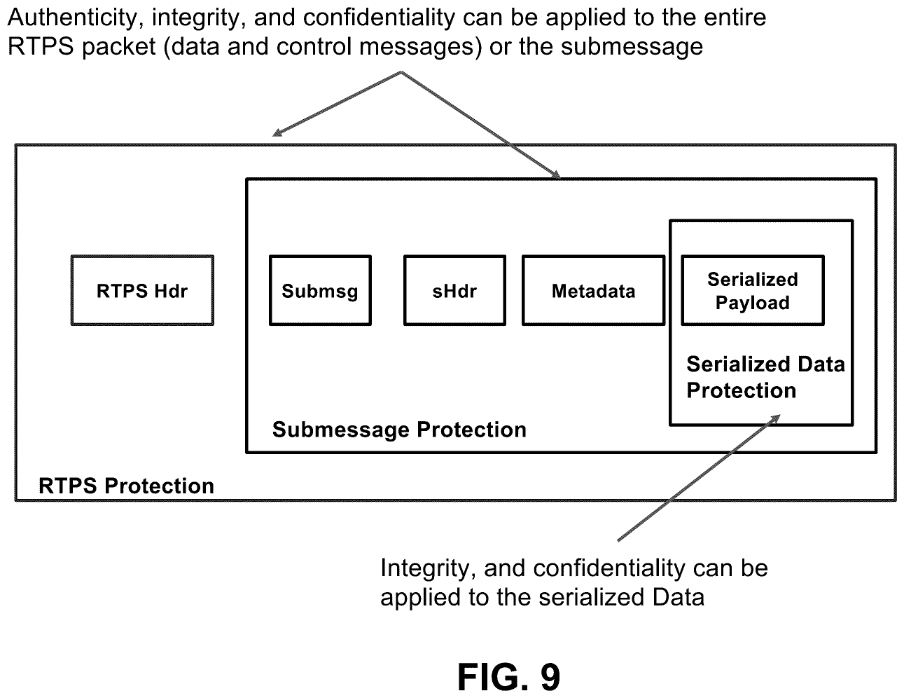

First, note that DDS Security supports authenticity, integrity, and confidentiality, or a combination of the three for both data and control messages. In addition, a combination of authenticity, integrity, and confidentiality protections can also be applied to the RTPS payload, known as the submessage. Last, DDS Security also supports a third layer of protection to the serialized message (the payload), which includes Confidentiality and Integrity (FIG. 9).

### DDS Security Artifacts-The Governance File

The exact configuration that controls the level of protections to be applied to each message and the various parts of the RTPS packet is specified by the user within an XML file called the Governance File. The governance file has a list of domain and topic rules that define the fine-grained security required for each domain and topic in the system.

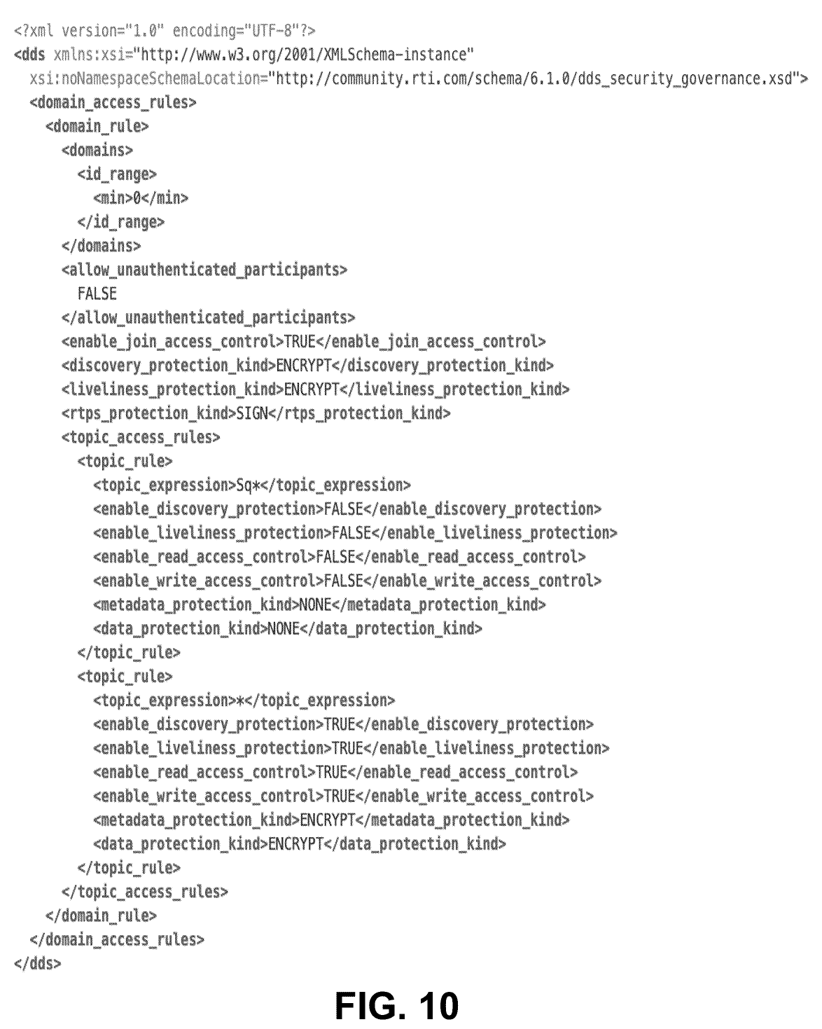

The example Governance File XML shown in FIG. 10 defines one configuration to be applied to all domains that may be created within the system (e.g. there is one domain_rule in the configuration), and two topic configurations (two topic_rules). Specifically, the rules specified in this example determine that:
1) The integrity of all RTPS messages will be validated.
2) No additional security is specified for topics when their names start with “Sq”.
3) The serialized data and the control messages of all other topics will be encrypted.

Note that a governance file must be signed by the DDS application's assigned private certificate before it can be used by that application.

### DDS Security Artifacts—The Permissions File

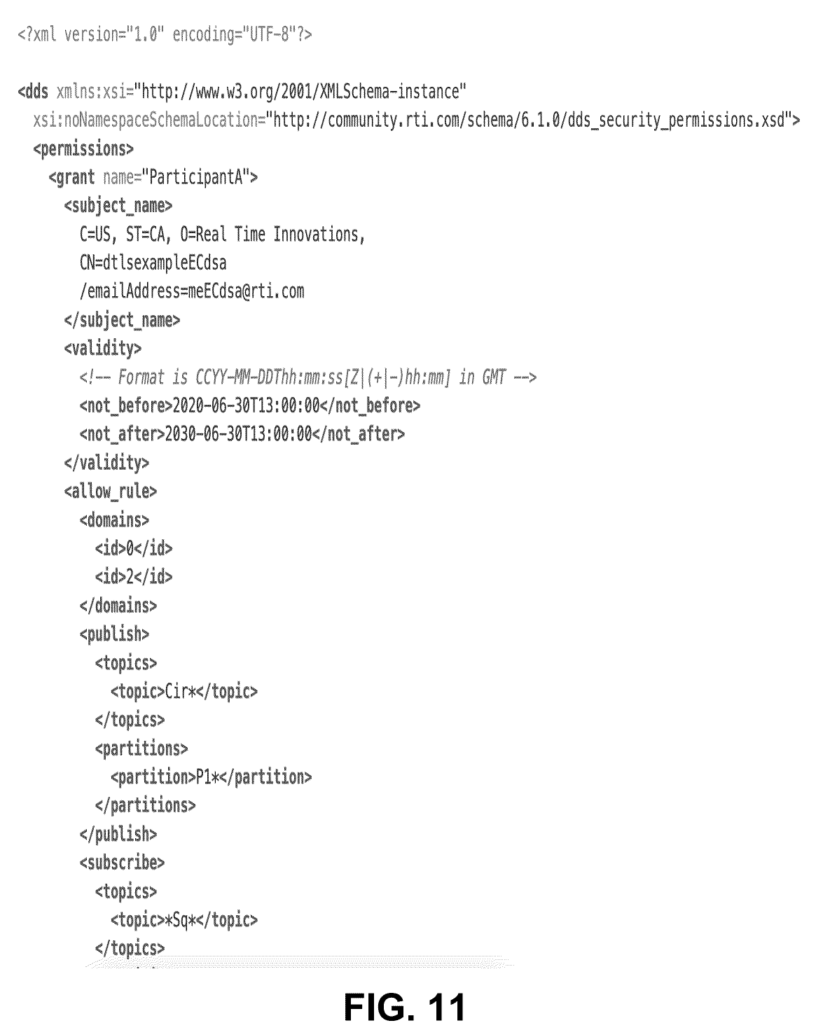

In addition to the governance file, DDS Security uses a Permissions File to define access rules. The access rules control how each DDS domain participant is allowed to act in a specific domain, similar to read/write permissions in a file system. The permissions file has a set of allow and deny rules in an XML file. Each rule specifies if the participant is allowed, or denied, to publish or subscribe to a topic in a given domain. The default behavior of DDS Security is to “deny all” communications, and therefore, it is important to configure allow rules for all trusted participants. FIG. 11 shows an example Permissions file.

The numerous configuration possibilities and the multiple protection layers make DDS Security a powerful framework for distributed real-time applications. At the same time, the manual configuration needed to create those protection rules in the governance file today are error-prone. This can result in undesired security flaws in large-scale systems. Our invention automates the generation of these files—both the governance and permissions files will be autogenerated (by Cameo) as part of the security artifacts that are added to the Cameo model by a cyber-modeling expert.

### Deployment-Specific Artifact Generation

Note that some of the information in the security artifacts files may only be known at deployment time. To automate the generation of the needed security artifacts, one can utilize deployment details (e.g., from deployment models). These information sources can be extended with deployment-specific security policies. These policies will be used to automatically create the required security artifacts, or amend existing ones. The artifacts can then be deployed to the system along with the applications.

### Threat Modeling

Threat modeling is a proactive approach that helps identify potential risks in a given system. Threat modeling is a structured process for identifying potential security threats and vulnerabilities, quantifying the risk of each, and prioritizing mitigation techniques. In data-centric distributed systems, threat modeling could be the process of identifying the system's assets and listing the potential attacks a malicious actor can perform on each of those assets. Based on the list of assets and the attack vectors, a security expert can identify the mitigations needed, and prioritize their implementation in the system based on the risk the attack presents, the importance of the asset, and the mitigation cost.

For instance, consider if an attacker gained access to a system, and can now steal information sent from one application to another. This may present a risk if the information in the clear is a bank password but may not present a risk if this is an AC temperature measurement. DDS Security supports such fine-grained consideration, and a security policy can be created for each one of these topics.

### What is STRIDE?

STRIDE is a model for identifying security threats and defining the trust and mitigations boundaries of a system. The STRIDE model in one embodiment has six threats: Spoofing, Tampering, Repudiation, Information Disclosure, Denial of Service, and Elevation of Privilege. Each of the STRIDE threats associates with a different security property as defined in the following table:

| | THREAT | DESIRED PROPERTY |
|---|---|---|
| S | Spoofing | Authentication |
| T | Tampering | Integrity |
| R | Repudiation | Non-repudiation |
| I | Information Disclosure | Confidentiality |
| D | Denial of Service | Availability |
| E | Elevation of Privilege | Authorization |

Using STRIDE, a security expert can define which of the above properties is at risk for each communication flow and prioritize the mitigation requirements.

What is claimed is:

1. A method for visually modeling and validating cybersecurity configurations to generate security configurations for Data Distributed Service (DDS) systems, comprising:
(a) on a computer system having a software implemented and operable data-centric model of a Data Distribution Service (DDS) data exchange system exchanging data between data producers and data consumers,
wherein the Data Distribution Service (DDS) data exchange system has security settings;
wherein the data-centric model is defined by DDS constructs and DDS security policies,
wherein the DDS constructs include DDS topics to which the data producers can publish on and the data consumers can subscribe to,
wherein the DDS security policies are domain security policies defining protections for RTPS packets sent within one or more DDS domains and topic security policies defining protections for RTPS packets with the DDS topics, and
wherein the DDS constructs and the DDS security policies are linked to each other within the data-centric model by assigning the DDS security policies to the DDS topics and the one or more DDS domains;
(b) on the computer system having a software implemented and operable validation code for validating the domain security policies and the topic security policies for the data centric model, wherein the validating is performed with a validation model; and
(c) the computer system generating a set of security configuration files from the validating step and from the validation model, wherein the set of security configuration files are used by the Data Distribution Service (DDS) data exchange system to configure the security settings of the Data Distribution Service (DDS) data exchange system.

2. The method as set forth in claim 1, the computer system further comprising having a software implemented and an operable translation code for interpreting STRIDE threat security policies and translating them into the DDS security policies.

3. A method for visually modeling and validating cybersecurity configurations to generate security configurations for data-centric communications system, comprising:
(a) on a computer system having a software implemented and operable data-centric model of a data exchange system exchanging data between data producers and data consumers,
wherein the data exchange system has security settings;
wherein the data-centric model is defined by communications constructs and communications security policies,
wherein the communications constructs include data types to which the data producers can send on and the data consumers can receive,
wherein the communications security policies define protections for the data sent from the data producers to the data consumers, and
wherein the communications constructs and the communications security policies are linked to each other within the data-centric model by assignment of the security policies to the data types;
(b) on the computer system having a software implemented and operable validation code for validating the defined protections for the data centric model, wherein the validating is performed with a validation model; and
(c) the computer system generating a set of security configuration files from the validating step and from the validation model, wherein the set of security configuration files are used by the data exchange system to configure the security settings of the data exchange system.

4. The method as set forth in claim 3, the computer system further comprising having a software implemented and an operable translation code for interpreting STRIDE threat security policies and translating them into the security policies.
